(19) United States
(12) Patent Application Publication
(10) Pub. No.: US 2022/0106431 A1
(43) Pub. Date: Apr. 7, 2022

(54) ISOCYANATE-TERMINATED PREPOLYMERS FOR THE PRODUCTION OF INTEGRAL POLYURETHANE FOAMS

(71) Applicant: Covestro Intellectual Property GmbH & Co. KG, Leverkusen (DE)

(72) Inventors: Jakob Marbach, Köln (DE); Hans-Detlef Arntz, Overath (DE); Rolf Albach, Köln (DE); Annika Hill, Köln (DE); Sascha Froebel, Düsseldorf (DE); Markus Meuresch, Köln (DE); Marc Schumacher, Bergheim (DE); Stephan Kretschmann, Oldenburg (DE); Ludger Schlag, Sandhatten (DE)

(21) Appl. No.: 17/430,954

(22) PCT Filed: Feb. 28, 2019
(86) PCT No.: PCT/EP2019/054975

§ 371 Date: Aug. 13, 2021

(51) Int. Cl. C08G 18/32; C08G 18/08; C08G 18/40; C08G 18/48; C08G 18/56; C08G 18/66; C08G 18/72; C08G 18/76; C08G 18/79; C08K 5/095; C08K 5/521; C08J 9/02

(52) U.S. Cl. CPC C08G 18/3206; C08J 2375/08; C08G 18/4036; C08G 18/4829; C08G 18/4866; C08G 18/56; C08G 18/6674; C08G 18/725; C08G 18/7671; C08G 18/797; C08K 5/095; C08K 5/521; C08J 9/02; C08G 2120/00; C08G 2410/00; C08G 2110/0008; C08G 2110/0066; C08J 2205/06; C08G 18/089

(57) ABSTRACT

A method for producing a prepolymer for the production of an integral polyurethane foam is provided. The prepolymer is or can be obtained by reaction of a composition that contains the following components: component A containing a polyoxymethylene-polyoxyalkylene block copolymer having a hydroxyl number of 20 mg KOH/g to 200 mg KOH/g as component Al, component B containing di- and/or polyisocyanates with an NCO content of 15 to 45 wt.-% relative to component B, 0.04 to 1.0 wt.-%, relative to the composition, a proton acid as component C, and optionally a component D that contains auxiliary agents, at a characteristic number of 450 to 850. The invention further relates to the prepolymer obtained by the method, to an integral polyurethane foam based on the prepolymer, and to the use thereof.

### CROSS REFERENCE TO RELATED APPLICATIONS

This application is a U.S. national stage application, filed under 35 U.S.C. § 371, of International Application No. PCT/EP2019/054975, which was filed on Feb. 28, 2019. The contents of each are hereby incorporated by reference into this specification.

### FIELD

The invention relates to a process for preparing a prepolymer for the production of an integral polyurethane foam, wherein the composition for preparation of the prepolymer contains an acid, and to the prepolymer obtained by the process and to an integral polyurethane foam based on the prepolymer.

### BACKGROUND

Moldings made of integral polyurethane foam have a cellular core and a largely cell-free edge zone. Since the skin that forms during the production process consists of the same material as the cell core, i.e. is an integral part of the molding, this type of polyurethane foam is referred to as integral foam. Integral polyurethane foam has found wide use, inter alia, as material for shoe soles. This material is usually flexible integral foam having an apparent density in the range from 0.3 to 0.6 g/cm³. Flexible integral foam is also used in the automotive industry.

Integral polyurethane foam is generally produced by mixing an isocyanate component and a polyol component and optionally auxiliaries and additives with one another and then pouring the mixture into a mold, where they react to form a foam. Such methods are referred to as reactive injection molding or RIM methods. The components used here have high reactivity, and so they have to be dosed and mixed within a short time to give a reaction mixture. In addition, it has to be ensured that a mold can be filled rapidly with the reaction mixture. In order to achieve good mixing of the components and to ensure rapid filling into the molds, the components must have a low viscosity of ≤1500 mPa*s at 25° C. Since the components may be stored for a period of time prior to further processing, their properties should not change in the course of storage. In these processes, it has been found to be advantageous to use isocyanate-terminated prepolymers as isocyanate component, in order to meet the demands on the preparation process and the resultant integral polyurethane foam.

Isocyanate-terminated prepolymers are generally obtained by first preparing a polyether polyol or polyester polyol by reacting the corresponding monomers with a catalyst, and then reacting the polyol with a poly- or diisocyanate. It has been observed that, in the course of storage, there is an increase in the viscosity of the prepolymers and also a fall in the content of free isocyanate groups required for the later reaction to give the polyurethane. This can probably be attributed to the fact that the terminal isocyanate groups of the prepolymers react with one another, resulting in trimerization and/or oligomerization of the isocyanates. This has an adverse effect both on the reactivity of the prepolymer and on the processibility thereof in the process for preparing the polyurethane. This effect occurs especially in the case of use of polyols that have been prepared by means of double metal cyanide catalysts (DMC catalysts).

The prior art discloses various prepolymers for polyurethane synthesis.

CN 101353413 discloses a prepolymer having terminal MDI-based isocyanate groups for the production of high-resilience polyurethane foam. The prepolymer is obtained by reacting a polyether polyol with isocyanate and an acid as polymerization inhibitor. The prepolymer is intended to overcome problems that arise from the use of unmodified MDI in the production of high-resilience polyurethane foam. The document is not concerned with the properties of the prepolymer, but relates exclusively to the properties of the resultant high-resilience polyurethane foam.

WO 2014/095679 discloses NCO-modified polyoxymethylene block copolymers and the use thereof as prepolymer for production of flexible polyurethane foams and thermoplastic polyurethanes. The document discloses that the viscosity of the prepolymer can be controlled via the length of the polyoxymethylene blocks relative to the additional oligomers. The document is not concerned with the storage stability of the prepolymer.

EP 1 589 071 A1 discloses a polyether polyol for the preparation of isocyanate-terminated prepolymers for elastomers, sealants based on polyurethane. The polyol is prepared by ring-opening polymerization of alkylene oxide in the presence of a DMC catalyst and a phosphoric acid and/or a phosphoric ester, and then reacted with an isocyanate. The resultant prepolymer is said to have improved storage stability. The experimental part discloses isocyanate-terminated prepolymers having a viscosity at 25° C. of 29 700 to 31 200 mPa*s. However, prepolymers having such a high viscosity cannot be used in production processes for integral polyurethane foams because they cannot be introduced quickly enough into a mold.

There is a need for isocyanate-terminated prepolymers for the production of integral polyurethane foams that have a low viscosity of ≤1500 mPa*s at 25° C., and the properties of which barely change during storage over a period of several months at 25° C. under protective gas atmosphere.

### SUMMARY

It is an object of the present invention to provide an isocyanate-terminated prepolymer that has a low dynamic viscosity of ≤1500 mPa*s at 25° C. and has improved storage stability. This is especially true of changes in dynamic viscosity and in the NCO content of the prepolymer that occur during storage. More particularly, an isocyanate-terminated prepolymer having the aforementioned properties is to be provided, in the preparation of which a polyol component that has been prepared in the presence of a DMC catalyst is used, and which still contains the DMC catalyst in an amount of 10 to 5000 ppm. In addition, the prepolymer is to be suitable for use in the production of shoe soles.

This object was achieved by a process for preparing a prepolymer for production of an integral polyurethane foam, wherein the prepolymer is obtained or obtainable by conversion of a composition comprising or consisting of the following components:

component A comprising or consisting of
a polyoxymethylene-polyoxyalkylene block copolymer having a hydroxyl number to DIN 53240-2 (November 2007) of 20 mg KOH/g to 200 mg KOH/g as component A1,
optionally a polymer that is different from component A1 and has an average number of at least 1.7 Zerewitinoff-active hydrogen atoms and a hydroxyl number to DIN 53240-2 (November 2007) of 40 mg KOH/g to 80 mg KOH/g as component A2,
optionally a compound that is different from components A1 and A2 and has at least two Zerewitinoff-active hydrogen atoms and a molecular weight of 50 to 500 g/mol as component A3,

component B comprising or consisting of di- and/or polyisocyanates having an NCO content to EN ISO 11909 (2007) of 15% to 45% by weight, based on component B,

0.04% to 1.0% by weight, based on the composition, of a protic acid as component C,

and optionally a component D comprising auxiliaries,

at an index of 450 to 850.

### DETAILED DESCRIPTION

An improved storage stability is understood to mean that there is no more than a 55% increase in the dynamic viscosity of the prepolymer after storage for six months at 25° C. under protective gas atmosphere. These storage conditions can be simulated by storing a sample at 80° C. over a period of 3 days under nitrogen atmosphere. In addition, there should be no more than a 10% drop in the NCO content of the prepolymer during storage under the abovementioned conditions, such that the reactivity of the prepolymer, even after storage, is sufficiently high for the production of an integral polyurethane foam.

The isocyanate index (also called index) is understood to mean the quotient of the molar amount [mol] of isocyanate groups actually used and the molar amount [mol] of isocyanate-reactive groups actually used, multiplied by 100:
index=(moles of isocyanate groups/moles of isocyanate-reactive groups)*100
The NCO value (also called NCO content, isocyanate content) is determined to EN ISO 11909:2007. The values are at 25° C. unless stated otherwise.

### Component A1

Component A1 is a polyoxymethylene-polyoxyalkylene block copolymer having a hydroxyl number to DIN 53240-2 (November 2007) of 20 mg KOH/g to 200 mg KOH/g, preferably of 30 mg KOH/g to 150 mg KOH/g, further preferably of 40 mg KOH/g to 100 mg KOH/g. The composition for preparation of the prepolymer preferably contains 10.50% by weight to 30.50% by weight of component A1, based on the sum total of all components in the composition. Polyoxymethylene-polyoxyalkylene block copolymers in the context of the invention refer to polymeric compounds which contain at least one polyoxymethylene block and at least one additional polyoxyalkylene or polyoxyalkylene carbonate block and preferably do not exceed a molecular weight in the four-digit range.

Preference is given to preparing component A1 by catalytic addition of alkylene oxides and optionally further comonomers onto at least one polymeric formaldehyde starter compound having at least one terminal hydroxyl group in the presence of a double metal cyanide (DMC) catalyst, wherein
(i) in a first step the DMC catalyst is activated in the presence of the polymeric formaldehyde starter compound at an activation temperature (Tact) of 20 to 120° C., wherein the DMC catalyst is activated by adding a portion (based on the total amount of the amount of alkylene oxides used in the activation and polymerization) of one or more alkylene oxides (“activation”),
(ii) in a second step one or more alkylene oxides and optionally further comonomers are added to the mixture that results from step (i), wherein the alkylene oxides used in step (ii) are different than the alkylene oxides used in step (i) (“polymerization”).

Suitable polymeric formaldehyde starter compounds are in principle those oligomeric and polymeric forms of formaldehyde that have at least one terminal hydroxyl group for reaction with the alkylene oxides and any further comonomers. What is meant more particularly by the term “terminal hydroxyl group” is a terminal hemiacetal functionality which results as a structural feature from the polymerization of formaldehyde. For example, the starter compounds may be oligomers and polymers of formaldehyde of the general formula HO (CH₂O)n—H where n is an integer ≥2 and where polymeric formaldehyde typically has n>8 repeat units.

Preferred polymeric formaldehyde starter compounds generally have molar masses of 62 to 30 000 g/mol, preferably of 62 to 12 000 g/mol, more preferably of 242 to 6000 g/mol and most preferably of 242 to 3000 g/mol, and comprise from 2 to 1000, preferably from 2 to 400, more preferably from 8 to 200 and most preferably from 8 to 100 repeat oxymethylene units. The starter compounds used typically have a functionality (F) of 1 to 3, but in certain cases may also have higher functionality, i.e. have a functionality of >3. It is preferable to use open-chain polymeric formaldehyde starter compounds having terminal hydroxyl groups and having a functionality of 1 to 10, preferably of 1 to 5, more preferably of 2 to 3. It is most preferable to use linear polymeric formaldehyde starter compounds having a functionality of 2. The functionality F corresponds to the number of OH end groups per molecule.

The polymeric formaldehyde starter compounds that are used for the process for preparing component A1 can be prepared by known processes (cf., for example, M. Haubs et al., 2012, Polyoxymethylenes, Ullmann's Encyclopedia of Industrial Chemistry; G. Reus et al., 2012, Formaldehyde, ibid.). The formaldehyde starter compounds can in principle also be used in the form of a copolymer, in which case comonomers incorporated in the polymer in addition to formaldehyde are, for example, 1,4-dioxane or 1,3-dioxolane. Further suitable formaldehyde copolymers are copolymers of formaldehyde and of trioxane with cyclic and/or linear formals, for example butanediol formal, or epoxides. It is likewise conceivable for higher homologous aldehydes, for example acetaldehyde, propionaldehyde, etc., to be incorporated into the formaldehyde polymer as comonomers. It is likewise conceivable for formaldehyde starter compounds in turn to be prepared from H-functional starter compounds; the use of polyfunctional starter compounds in particular makes it possible to obtain polymeric formaldehyde starter compounds having a hydroxyl end group functionality F>2 (cf., for example, WO 1981001712 A1, Bull. Chem. Soc. J., 1994, 67, 2560-2566, U.S. Pat. No. 3,436,375, JP 03263454, JP 2928823).

Also usable for the process for preparing component A1 are mixtures of different polymeric formaldehyde starter compounds or mixtures with other H-functional starter compounds. Suitable H-functional starter substances (“starters”) used may be compounds having alkoxylation-active hydrogen atoms and having a molar mass of 18 to 4500 g/mol, preferably of 62 to 2500 g/mol and more preferably of 62 to 1000 g/mol. Alkoxylation-active groups having active hydrogen atoms are, for example, —OH, —NH2 (primary amines), —NH— (secondary amines), —SH, and —CO2H, preference being given to —OH and —NH2, particular preference to —OH. H-functional starter substances used are, for example, one or more compounds selected from the group consisting of mono- or polyhydric alcohols, polyfunctional amines, polyhydric thiols, amino alcohols, thio alcohols, hydroxy esters, polyether polyols, polyester polyols, polyester ether polyols, polyether carbonate polyols, polycarbonate polyols, polycarbonates, polyethyleneimines, polyetheramines, polytetrahydrofurans (e.g. PolyTHF® from BASF), polytetrahydrofuran amines, polyether thiols, polyacrylate polyols, castor oil, the mono- or diglyceride of ricinoleic acid, monoglycerides of fatty acids, chemically modified mono-, di- and/or triglycerides of fatty acids, and C1-C24 alkyl fatty acid esters containing an average of at least 2 OH groups per molecule.

As is well known, polymerization of formaldehyde proceeds in the mere presence of small traces of water. In aqueous solution, therefore, depending on the concentration and temperature of the solution, a mixture of oligomers and polymers of different chain lengths is formed, in equilibrium with molecular formaldehyde and formaldehyde hydrate. What is called paraformaldehyde precipitates out of the solution here as a white, sparingly soluble solid, and is generally a mixture of linear formaldehyde polymers where n=8 to 100 repeat oxymethylene units.

In one embodiment, polymeric formaldehyde, i.e. what is called paraformaldehyde, which is commercially available at low cost, is used directly as the starter compound. It is possible in particular via the molecular weight and the end group functionality of the polymeric formaldehyde starter compound to introduce polyoxymethylene blocks of defined molar weight and functionality into the product.

In the process for preparing component A1, it is advantageously possible here to control the length of the polyoxymethylene block in a simple manner via the molecular weight of the formaldehyde starter compound used. Preference is given here to using linear formaldehyde starter compounds of the general formula HO—(CH₂O)n—H where n is an integer ≥2, preferably with n=2 to 1000, more preferably with n=2 to 400 and most preferably with n=8 to 100, having two terminal hydroxyl groups. Starter compounds used may in particular also be mixtures of polymeric formaldehyde compounds of the formula HO—(CH2O)n—H that each have different values of n. In a preferred embodiment, the used mixtures of polymeric formaldehyde starter compounds of the formula HO—(CH₂O)n—H contain at least 1% by weight, preferably at least 5% by weight and more preferably at least 10% by weight of polymeric formaldehyde compounds with n≥20.

By means of the process for preparing component A1, it is especially possible to obtain polyoxymethylene block copolymers having an A-B-A block structure comprising an inner polyoxymethylene block (B) and outer oligomeric blocks (A). It is likewise possible that formaldehyde starter compounds having a hydroxyl end group functionality F>2 are used, by means of which it is consequently possible to prepare homologous block structures B(−A)y having a number y>2 of outer oligomeric blocks (A) that results in accordance with the functionality of the formaldehyde starter compound used. It is likewise possible in principle that formaldehyde starter compounds having a functionality F<2 are used; these may, for example, also be linear formaldehyde starter compounds with F=1 that are substituted at one end of the chain by a protecting group or by other chemical radicals.

It is preferable that component A1 consists of a polyoxymethylene-polypropylene oxide block copolymer or a polyoxymethylene-polyoxyalkylene carbonate block copolymer, where the block copolymer preferably has two terminal polyoxyalkylene blocks.

It is preferable that the outer oligomeric blocks (A) are polyoxyalkylene or polyoxyalkylene carbonate blocks, where polyoxyalkylene or polyoxyalkylene carbonate blocks in the context of the invention are also understood to mean blocks incorporating (small) proportions of further comonomers, generally of less than 50 mol %, preferably less than 25 mol %, based on the total amount of all the repeat units present in the oligomeric block.

A polyoxyalkylene carbonate block in the context of the invention refers to a polymeric structural unit O[(C₂R¹R²R³R⁴O)ₓ(CO₂)(C₂R¹R²R³R⁴O)_{y}]_{z}— where x≥1, y≥0 and z≥1, wherein R¹, R², R³ and R⁴ may independently be hydrogen, an alkyl or aryl radical optionally containing additional heteroatoms such as nitrogen, oxygen, silicon, sulfur or phosphorus, and may differ in different repeat units. The term “alkyl” in the context of the overall invention generally includes substituents from the group of n-alkyl such as methyl, ethyl or propyl, branched alkyl and/or cycloalkyl. The term “aryl” in the context of the overall invention generally includes substituents from the group of monocyclic carbo- or heteroaryl substituents such as phenyl and/or polycyclic carbo- or heteroaryl substituents which may optionally be substituted by further alkyl groups and/or heteroatoms such as nitrogen, oxygen, silicon, sulfur or phosphorus. The R¹, R², R³ and R⁴ radicals may be joined to one another within a repeat unit such that they form cyclic structures, for example a cycloalkyl radical incorporated into the polymer chain via two adjacent carbon atoms.

The DMC catalyst is preferably activated in the presence of the polymeric formaldehyde starter compound. The starter compound and the DMC catalyst may optionally be suspended in a suspension medium. It is likewise also possible to use a further liquid starter compound (“co-starter”) in the mixture, in which case the DMC catalyst and the polymeric formaldehyde starter compound are suspended therein.

According to the invention, the DMC catalyst is activated at an activation temperature Tact in the range from 20° C. to 120° C., preferably at 30° C. to 120° C., more preferably at 40° C. to 100° C. and most preferably at 60° C. to 100° C.

“Activation” of the DMC catalyst is understood to mean a step in which a portion of alkylene oxide is added to the DMC catalyst suspension at the specific activation temperature and then the addition of the alkylene oxide is stopped, with observation of evolution of heat that can lead to a temperature spike (“hotspot”) owing to a subsequent exothermic chemical reaction, and of a pressure drop in the reactor owing to the conversion of alkylene oxide.

DMC catalysts suitable for the process for preparing component A1 for use in the homopolymerization of alkylene oxides are known in principle from the prior art (see, for example, U.S. Pat. Nos. 3,404,109, 3,829,505, 3,941,849 and 5,158,922). DMC catalysts, described, for example, in U.S. Pat. No. 5,470,813, EP-A 700 949, EP-A 743 093, EP-A 761 708, WO 97/40086, WO 98/16310 and WO 00/47649, have very high activity in the polymerization of alkylene oxides and in some cases the copolymerization of alkylene oxides with suitable comonomers, and they enable the preparation of polyoxymethylene copolymers at very low catalyst concentrations, so that there is generally no longer any need to separate the catalyst from the finished product. A typical example is that of the highly active DMC catalysts described in EP-A 700 949 which contain not only a double metal cyanide compound (e.g. zinc hexacyanocobaltate(III)) and an organic complex ligand (e.g. tert-butanol) but also a polyether having a number-average molecular weight greater than 500 g/mol. Preference is given to synthesizing components A1 using DMC catalysts that have been prepared with addition of a base, preferably KOH. Such a particularly preferred DMC catalyst is one according to example 6 of WO 01/80994 A1. Preference is given to using a DMC catalyst comprising zinc hexacyanocobaltate, tert-butanol and polypropylene glycol having a number-average molecular weight of about 1000 g/mol for synthesis of component A1.

The concentration of DMC catalyst used is typically 10 to 10 000 ppm, more preferably 20 to 5000 ppm and most preferably 50 to 2000 ppm, based on the mass of the polyoxymethylene block copolymer to be prepared. According to the profile of requirements for downstream use, the DMC catalyst can be left in the product or (partly) removed. The (partial) removal of the DMC catalyst can be effected, for example, by treatment with adsorbents and/or filtration. Processes for removing DMC catalysts are described, for example, in U.S. Pat. No. 4,987,271, DE-A 3132258, EP-A 0 406 440, U.S. Pat. Nos. 5,391,722, 5,099,075, 4,721,818, 4,877,906 and EP-A 0 385 619. Preferably in accordance with the invention, component A1, and possibly also further components of component A, contains a residual content of DMC catalyst(s), such that component A contains a total content of DMC catalyst(s) of 10 to 5000 ppm, preferably of 10 to 3000 ppm, based in each case on component A.

In a preferred embodiment of the process of the invention, at least component A1 has been prepared in the presence of a double metal cyanide catalyst, and component A1 still contains at least some of this double metal cyanide catalyst, where the content of double metal cyanide catalyst based on component A is 10 to 5000 ppm, preferably 1000 to 2500 ppm, and the content of double metal cyanide catalyst is ascertained by the amount of metal from the double metal cyanide catalyst found according to DIN ISO 17025 (August 2005). The amount of metal from the DMC catalyst can be ascertained either for the entire polyol component A, or alternatively separately for each of components A1 and A2. The figures as to the metal content from the DMC catalyst and the molecular weight of the DMC catalyst can then be used to calculate the amount of catalyst. It should be taken into account here that double metal cyanide catalysts may contain different metals in respectively different amounts. If the concentration of the double metal cyanide catalyst has been ascertained individually for the polyol components A1 or A2, the concentration of the double metal cyanide catalyst based on weight can be calculated using the weight-based average for the polyol component A overall.

Epoxides (alkylene oxides) used for the preparation of the polyoxymethylene-polyoxyalkylene block copolymers are preferably compounds of the general formula (I):

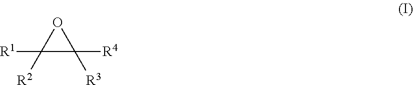

where R¹, R², R³ and R⁴ are independently hydrogen or an alkyl or aryl radical optionally containing additional heteroatoms, such as nitrogen, oxygen, silicon, sulfur or phosphorus, and may optionally be joined to one another so as to form cyclic structures, for example a cycloalkylene oxide.

Preference is given to using those alkylene oxides suitable for polymerization in the presence of a DMC catalyst. If different alkylene oxides are used, these may be metered in either as a mixture or consecutively. In the case of the latter metered addition, the polyether chains of the polyoxymethylene-polyoxyalkylene block copolymer obtained in this way may in turn likewise have a block structure.

In general, it is possible to use alkylene oxides (epoxides) having 2-24 carbon atoms. The alkylene oxides having 2-24 carbon atoms are, for example, one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, mono- or polyepoxidized fats as mono-, di- and triglycerides, epoxidized fatty acids, C1-C24 esters of epoxidized fatty acids, epichlorohydrin, glycidol, and derivatives of glycidol, for example methyl glycidyl ether, ethyl glycidyl ether, 2-ethylhexyl glycidyl ether, allyl glycidyl ether, glycidyl methacrylate, and epoxy-functional alkoxysilanes, for example 3-glycidyloxypropyltrimethoxysilane, 3-glycidyloxypropyltriethoxysilane, 3-glycidyloxypropyltripropoxysilane, 3 -glycidyloxypropylmethyldimethoxysilane, 3-glycidyloxypropylethyldiethoxysilane, 3-glycidyloxypropyltriisopropoxysilane. The epoxide of the general formula (I) is preferably a terminal epoxide where R¹, R² and R³ are hydrogen and R⁴ may be hydrogen, an alkyl or aryl radical optionally containing additional heteroatoms such as nitrogen, oxygen, silicon, sulfur or phosphorus and may differ in different repeat units. Alkylene oxides used with preference are ethylene oxide and/or propylene oxide, especially propylene oxide.

The process of the invention is preferably performed in such a way that the activation of the catalyst and the conditioning of the polymeric formaldehyde starter compound in step (β) are followed by a polymerization step (γ) with metered addition of one or more alkylene oxides.

In a further embodiment of the process of the invention, the alkylene oxides are polymerized in the presence of a further comonomer. Further comonomers used may, for example, be any oxygen-containing cyclic compounds, especially cyclic ethers, for example oxetane, THF, dioxane or cyclic acetals, for example 1,3-dioxolane or 1,3-dioxepane, cyclic esters, for example γ-butyrolactone, γ-valerolactone, ε-caprolactone, or cyclic acid anhydrides, for example maleic anhydride, glutaric anhydride or phthalic anhydride, and carbon dioxide. Preference is given to using carbon dioxide as a comonomer.

Further comonomers may be metered into the reaction in pure form, in solution or as a mixture with one or more alkylene oxides. The metered addition of further comonomers may likewise be effected in parallel with or subsequently to the metered addition of the alkylene oxides.

A preferred embodiment of the process of the invention comprises not only addition of the alkylene oxide(s) onto the polymeric formaldehyde starter compound but also addition of carbon dioxide (CO₂) as a further comonomer. In this way, it is possible to prepare polyoxymethylene-polyoxyalkylene carbonate copolymers. Compared to existing products (for example polyether polyols in the polyurethane sector or polyoxymethylene (co-)polymers in the POM sector), these additionally include CO₂ as an inexpensive and environmentally friendly comonomer. Since CO₂ is, inter alia, a waste product from energy generation from fossil raw materials and is being sent here to chemical reutilization, the incorporation of CO₂ into the polymer structures provides not only economic but also environmental benefits (favorable CO₂ balance of the product polymers, etc.).

Polyoxymethylene-polyoxyalkylene carbonate block copolymers in the context of the invention refer to polymeric compounds containing at least one polyoxymethylene block and at least one polyoxyalkylene carbonate block. Polyoxymethylene-polyoxyalkylene carbonate block copolymers are of particular interest as feedstocks in the polyurethane sector and for applications in the polyoxymethylene (POM) sector. By altering the CO₂ content, the physical properties can be matched to the particular use, thus making it possible to develop new fields of application for these block copolymers. The process according to the invention especially makes it possible to provide polyoxymethylene-polyoxyalkylene carbonate copolymers, wherein a high content of incorporated CO₂ is achieved and the products have a comparatively low polydispersity and contain a very low level of by-products and decomposition products of the polymeric formaldehyde.

### Component A2

Component A2 which is optionally present in the composition is a polymer that is different than component A1 and has an average number of at least 1.7 Zerewitinoff-active hydrogen atoms and a hydroxyl number to DIN 53240-2 (November 2007) of 40 mg KOH/g to 80 mg KOH/g, preferably of 45 mg KOH/g to 65 mg KOH/g, more preferably of 50 mg KOH/g to 60 mg KOH/g. The composition for preparation of the prepolymer preferably contains 0.50% by weight to 3.50% by weight of component A2, based on the sum total of all components in the composition.

Component A2 preferably has an average number of Zerewitinoff-active hydrogen atoms of not more than 4; component A2 more preferably has an average number of 1.9 to 2.5 Zerewitinoff-active hydrogen atoms. Hydrogen bonded to N, O or S is referred to as Zerewitinoff-active hydrogen (or as “active hydrogen”). A hydrogen atom of this kind can be determined in a manner known per se by reactivity with an appropriate Grignard reagent. The amount of Zerewitinoff-active hydrogen atoms is typically measured via the release of methane which is released in a reaction of the substance to be examined with methylmagnesium bromide (CH₃—MgBr) according to the following reaction equation (formula 1):

CH₃—MgBr+ROH→CH₄+Mg(OR)Br (1)

Zerewitinoff-active hydrogen atoms typically originate from C—H-acidic organic groups, —OH, —SH, —NH2 or —NHR with R as organic radical and —COOH.

Component A2 preferably comprises or consists of a polyether polyol, polyester polyol, polyether ester polyol, polycarbonate polyol or polyacrylate polyol or mixtures thereof. In a preferred embodiment, component A2 comprises or consists of a branched polypropylene oxide.

It is preferable that the polymer present in component A2 has a number-average molecular weight Mn of ≥62 g/mol to ≤8000 g/mol, preferably of ≥90 g/mol to ≤5000 g/mol and more preferably of ≥92 g/mol to ≤2000 g/mol. The number-average molecular weight may be determined in the present invention according to DIN 55672-1 (August 2007) by means of gel permeation chromatography with tetrahydrofuran as eluent using polystyrene standards. It is preferable that component A2, with an average number of at least 2 Zerewitinoff-active hydrogen atoms, has a number-average molecular weight Mn of 3740-750 g/mol, preferably 2800-1120 g/mol.

Preferred components A2 are polyethers based on polypropylene oxide and a starter molecule. Suitable starter molecules for the polyether polyols are, for example, water, ethylene glycol, diethylene glycol, butyl diglycol, glycerol, diethylene glycol, trimethylolpropane, propylene glycol, pentaerythritol, sorbitol, sucrose, ethylenediamine, toluenediamine, triethanolamine, butane-1,4-diol, hexane-1,6-diol, and low molecular weight hydroxyl-containing esters of such polyols with dicarboxylic acids.

Suitable polyester polyols include polycondensates of di- and also tri- and tetraols and di- and also tri- and tetracarboxylic acids or hydroxycarboxylic acids or lactones. Rather than the free polycarboxylic acids, it is also possible to use the corresponding polycarboxylic anhydrides or corresponding polycarboxylic esters of lower alcohols for preparation of the polyesters. Examples of suitable diols are ethylene glycol, butylene glycol, diethylene glycol, triethylene glycol, polyalkylene glycols such as polyethylene glycol, and also propane-1,2-diol, propane-1,3-diol, butane-1,3-diol, butane-1,4-diol, hexane-1,6-diol and isomers, neopentyl glycol or neopentyl glycol hydroxypivalate. In addition, it is also possible to use polyols such as trimethylolpropane, glycerol, erythritol, pentaerythritol, trimethylolbenzene or tris(hydroxyethyl) isocyanurate.

Examples of polycarboxylic acids that may be used include phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, succinic acid, 2-methylsuccinic acid, 3,3-diethylglutaric acid, 2,2-dimethylsuccinic acid, dodecanedioic acid, endomethylenetetrahydrophthalic acid, dimer fatty acid, trimer fatty acid, citric acid, or trimellitic acid. It is also possible to use the corresponding anhydrides as the acid source. If the average functionality of the polyol to be esterified is >2, it is additionally also possible to use monocarboxylic acids, for example benzoic acid and hexanecarboxylic acid. Examples of hydroxycarboxylic acids that may be used as co-reactants in the preparation of a polyester polyol having terminal hydroxyl groups include hydroxycaproic acid, hydroxybutyric acid, hydroxydecanoic acid, hydroxystearic acid and the like. Suitable lactones include caprolactone, butyrolactone and homologs.

Usable polycarbonate polyols are hydroxyl-containing polycarbonates, for example polycarbonate diols. These are obtainable by reacting carbonic acid derivatives, such as diphenyl carbonate, dimethyl carbonate or phosgene, with polyols, preferably diols. Examples of such diols are ethylene glycol, propane-1,2- and -1,3-diol, butane-1,3- and -1,4-diol, hexane-1,6-diol, octane-1,8-diol, neopentyl glycol, 1,4-bishydroxymethylcyclohexane, 2-methylpropane-1,3-diol, 2,2,4-trimethylpentane-1,3-diol, dipropylene glycol, polypropylene glycols, dibutylene glycol, polybutylene glycols, bisphenol A and lactone-modified diols of the abovementioned type.

Usable polyether ester polyols are those compounds containing ether groups, ester groups and OH groups. Organic dicarboxylic acids having up to 12 carbon atoms are suitable for producing the polyether ester polyols, preferably aliphatic dicarboxylic acids having ≥4 to ≤6 carbon atoms or aromatic dicarboxylic acids used individually or in a mixture. Examples include suberic acid, azelaic acid, decanedicarboxylic acid, maleic acid, malonic acid, phthalic acid, pimelic acid and sebacic acid and in particular glutaric acid, fumaric acid, succinic acid, adipic acid, phthalic acid, terephthalic acid and isoterephthalic acid. Derivatives of these acids that may be used include, for example, their anhydrides and also their esters and monoesters with low molecular weight monofunctional alcohols having ≥1 to ≤4 carbon atoms. Further components used for preparation of the polyether ester polyols are polyether polyols that are obtained by alkoxylating starter molecules, for example polyhydric alcohols. The starter molecules are at least difunctional, but may optionally also contain proportions of higher-functionality, especially trifunctional, starter molecules.

Starter molecules for these polyether polyols are, for example, diols having number-average molecular weights Mn of preferably ≥18 g/mol to ≤400 g/mol or of ≥62 g/mol to ≤200 g/mol, such as ethane-1,2-diol, propane-1,3-diol, propane-1,2-diol, butane-1,4-diol, pentene-1,5-diol, pentane-1,5-diol, neopentyl glycol, hexane-1,6-diol, heptane-1,7-diol, octane-1,8-diol, decane-1,10-diol, 2-methylpropane-1,3-diol, 2,2-dimethylpropane-1,3-diol, 3 -methylpentane-1,5-diol, 2-butyl-2-ethylpropane-1,3-diol, 2-butene-1,4-diol and 2-butyne-1,4-diol, ether diols such as diethylene glycol, triethylene glycol, tetraethylene glycol, dibutylene glycol, tributylene glycol, tetrabutylene glycol, dihexylene glycol, trihexylene glycol, tetrahexylene glycol and oligomer mixtures of alkylene glycols, such as diethylene glycol.

In addition to the diols, polyols having number-average functionalities of >2 to ≤8, or of ≥3 to ≤4 may also be used, examples being 1,1,1-trimethylolpropane, triethanolamine, glycerol, sorbitan and pentaerythritol and also triol- or tetraol-started polyethylene oxide polyols having average molecular weights of preferably ≥62 g/mol to ≤400 g/mol or of ≥92 g/mol to ≤200 g/mol.

Polyether ester polyols may also be prepared by alkoxylation of reaction products that are obtained by reaction of organic dicarboxylic acids and diols. Derivatives of these acids that may be used include, for example, their anhydrides, for example phthalic anhydride.

Polyacrylate polyols are obtainable by free-radical polymerization of hydroxyl-containing, olefinically unsaturated monomers or by free-radical copolymerization of hydroxyl-containing, olefinically unsaturated monomers optionally with other olefinically unsaturated monomers. Examples thereof are ethyl acrylate, butyl acrylate, 2-ethylhexyl acrylate, isobornyl acrylate, methyl methacrylate, ethyl methacrylate, butyl methacrylate, cyclohexyl methacrylate, isobornyl methacrylate, styrene, acrylic acid, acrylonitrile and/or methacrylonitrile. Suitable hydroxyl-containing, olefinically unsaturated monomers are in particular 2-hydroxyethyl acrylate, 2-hydroxyethyl methacrylate, the hydroxypropyl acrylate isomer mixture obtainable by addition of propylene oxide onto acrylic acid, and the hydroxypropyl methacrylate isomer mixture obtainable by addition of propylene oxide onto methacrylic acid. Terminal hydroxyl groups may also be in protected form. Suitable free-radical initiators are those from the group of the azo compounds, for example azoisobutyronitrile (AIBN), or from the group of the peroxides, for example di-tert-butyl peroxide.

Component A2 may be produced by means of DMC catalysis or else by other known preparation routes. In the case of use of a DMC catalyst, essentially the same details are applicable in this regard as presented for component A1.

### Component A3

Component A3 which is optionally present in the composition is a compound that is different from components A1 and A2 and has at least two Zerewitinoff-active hydrogen atoms and a molecular weight of 50 to 500 g/mol. It is preferable that component A3 is an oligoalkylene oxide having an OH number between 460 and 700 mg KOH/g and a functionality of 1.8 to 2.4. Component A3 preferably comprises or consists of diethanolamine, ethylenediamine, glycerol, tripropylene glycol, trimethylolpropane or mixtures thereof, where component A3 preferably comprises or consists of tripropylene glycol.

The composition for preparation of the prepolymer preferably contains 1.00% by weight to 8.00% by weight of component A3, based on the sum total of all components in the composition.

### Component B (Isocyanate)

Component B comprises or consists of di- and/or polyisocyanates having an NCO content to EN ISO 11909 (2007) of 15% to 45% by weight, preferably 25% to 35% by weight, based on component B.

The isocyanate component B may especially comprise an aliphatic or aromatic di- or polyisocyanate. Examples include butylene 1,4-diisocyanate, pentane 1,5-diisocyanate, hexamethylene 1,6-diisocyanate (HDI) or their dimers, trimers, pentamers, heptamers or nonamers or mixtures thereof, isophorone diisocyanate (IPDI), 2,2,4- and/or 2,4,4-trimethylhexamethylene diisocyanate, isomeric bis(4,4′-isocyanatocyclohexyl)methanes or mixtures thereof having any desired isomer content, cyclohexylene 1,4-diisocyanate, phenylene 1,4-diisocyanate, tolylene 2,4- and/or 2,6-diisocyanate (TDI), naphthylene 1,5-diisocyanate, diphenylmethane 2,2′- and/or 2,4′- and/or 4,4′-diisocyanate (MDI) and/or higher homologs (polymeric MDI), 1,3- and/or 1,4-bis(2-isocyanatoprop-2-yl)benzene (TMXDI), 1,3-bis(isocyanatomethyl)benzene (XDI), and alkyl 2,6-diisocyanatohexanoates (lysine diisocyanates) having C₁ to C₆ alkyl groups. Preference is given to MDI.

In addition to the abovementioned polyisocyanates, it is also possible to use proportions of modified diisocyanates having uretdione, isocyanurate, urethane, carbodiimide, uretonimine, allophanate, biuret, amide, iminooxadiazinedione and/or oxadiazinetrione structure, and also unmodified polyisocyanate having more than 2 NCO groups per molecule, for example 4-isocyanatomethyloctane 1,8-diisocyanate (nonane triisocyanate) or triphenylmethane 4,4′,4″-triisocyanate. Component B preferably comprises carbodiimide-modified diisocyanates having an NCO content to EN ISO 11909 (2007) of 20% to 50% by weight, preferably 25% to 35% by weight, based on the carbodiimide-modified diisocyanates.

The composition for preparation of the prepolymer preferably contains 67.85% by weight to 77.65% by weight of component B, based on the sum total of all components in the composition.

### Component C (Acid)

Component C is preferably an inorganic acid, a carboxylic acid, a halogenated carboxylic acid, a dicarboxylic acid, a hydroxycarboxylic acid, a sulfonic acid, a phosphoric acid, a phosphoric acid derivative, a para-toluenesulfonic acid, a sulfonic acid or an ammonium salt. More preferably, component C is an aromatic carboxylic acid or a saturated or unsaturated carboxylic acid, an unsaturated or a saturated dicarboxylic acid or an aromatic dicarboxylic acid.

Component C is preferably selected from the group consisting of benzoyl chloride, o-chlorobenzoic acid, ammonium nitrate, ammonium chloride, boron trichloride, boron trifluoride, bromoacetic acid, chloroacetic acid, trichloroacetic acid, 2-chloropropionic acid, citric acid, diethyl malonate, diphenylacetic acid, formic acid, cinnamic acid, salicylic acid, naphthoic acid, oxalic acid, fumaric acid, maleic acid, citraconic acid, adipic acid, glutaric acid, succinic acid, malonic acid, phthalic acid, isophthaloyl chloride, terephthaloyl chloride, malic acid, tartaric acid, uric acid (2,6,8-trihydroxypurine), picric acid (2,4,6-trinitrophenol), phosphoric acid, diphosphoric acid, dibutyl phosphate, sulfuric acid, hydrochloric acid, methanesulfonic acid and p-toluenesulfonyl chloride. Preferred components C are dibutyl phosphate, hydrochloric acid or 2-chloropropionic acid.

It is preferable that 0.04% to 0.5% by weight, preferably 0.04% to 0.3% by weight, of component C is present in the composition, based in each case on the composition. In a particularly preferred embodiment, the composition for preparation of the prepolymer contains 0.05% to 0.2% by weight of component C, based on the sum total of all components in the composition.

It is preferable that the amount of component C used is chosen such that the molar amount of the metals of the double metal cyanide catalyst n_{Met}(DMC) ascertained to DIN-ISO 17025 (August 2005) to the molar amount of component C n(C) is subject to the following relationship:

$${n}_{Met} ( DMC ) \cdot f = n ( C )$$

where f is a number from 1.0 to 20.0, preferably from 1.2 to 10.0, further preferably from 3.0 to 6.0, especially preferably from 3.5 to 5.0.

### Component D

Component D optionally present in the composition comprises auxiliaries, where the auxiliaries are preferably compounds having antioxidant action, so-called antioxidants. Suitable antioxidants are preferably sterically hindered phenols, which may be selected preferably from the group consisting of 2,6-di-tert-butyl-4-methylphenol (ionol), pentaerythritol tetrakis(3-(3,5-di-tert-butyl-4-hydroxyphenyl)propionate), octadecyl 3-(3,5-di-tert-butyl-4-hydroxyphenyl)propionate, triethylene glycol bis(3-tert-butyl-4-hydroxy-5-methylphenyl)propionate, 2,2′-thiobis(4-methyl-6-tert-butylphenol) and 2,2′-thiodiethyl bis[3-(3,5-di-tert-butyl-4-hydroxyphenyl)propionate]. These may be used either individually or in any desired combinations with one another as required. The composition for preparation of the prepolymer preferably contains 0.10% to 0.20% by weight of component D, based on the sum total of all components in the composition.

In a further preferred embodiment of the process of the invention, the prepolymer is obtained or obtainable by conversion of a composition comprising or consisting of
10.50% by weight to 30.50% by weight of component A1,
0.50% by weight to 3.50% by weight of component A2,
1.00% by weight to 8.00% by weight of component A3,
67.85% by weight to 77.65% by weight of component B,
0.05% to 0.2% by weight of component C,

0.10% to 0.20% by weight of component D,

where the percentages by weight are based on the sum total of all components of the composition, at an index of 600 to 650, preferably at an index of 610 to 630.

The invention further relates to a prepolymer obtained or obtainable by the process of the invention. The prepolymer preferably has an NCO content to EN ISO 11909 (2007) of 15% to 30% by weight, preferably of 18% to 21% by weight, based on the mass of the prepolymer. The prepolymer, after storage at 80° C. for three days, preferably has an NCO content to EN ISO 11909 (2007) that is not more than 10% lower, more preferably not more than 3% lower, than the NCO content of the prepolymer on commencement of storage.

In one embodiment, the prepolymer has a dynamic viscosity at 50° C. to DIN 53019 (2008) of ≤0.30 Pa*s, preferably ≤0.15 Pa*s. The prepolymer, after storage at 80° C. for three days, preferably has a dynamic viscosity at 50° C. to DIN 53019 (2008) that is not more than 50% higher, more preferably not more than 40% higher, than the dynamic viscosity of the prepolymer on commencement of storage. The dynamic viscosity to DIN 53019 (2008) is measured with a rheometer having a cone-plate configuration with a separation of 1 mm, at 25° C. and with a shear of 0.01 to 1000 l/s, the dynamic viscosity being the average of all measurement points that have been measured at an interval of 10 seconds for a period of 10 minutes.

The invention further relates to an integral polyurethane foam obtained or obtainable by conversion of a composition comprising or consisting of
a prepolymer obtained or obtainable by the process of the invention,
a polyol component having a hydroxyl number to DIN 53240-2 (November 2007) of 140 mg KOH/g to 200 mg KOH/g,
optionally auxiliaries and additives,
   at an index of 85 to 110.

The integral polyurethane foam preferably has a molded density of 450 to 700 g/l, more preferably of 550 to 650 g/l, the molding density being calculated by means of the volume and mass of a test specimen made of the integral polyurethane foam.

The integral polyurethane foam preferably has a Shore A hardness to DIN ISO 7619-1 (2012) of 50 to 65, more preferably of 55 to 62.

The integral polyurethane foam preferably has a tensile strength to DIN EN ISO 1798 (2008) of 2.5 to 9 MPa, more preferably of 3 to 5 MPa.

The integral polyurethane foam preferably has a tensile elongation to DIN EN ISO 1798 (2008) of 200% to 400%, more preferably of 250% to 380%.

The integral polyurethane foam preferably has a tear resistance to DIN EN ISO 8067 (2009) of 15 to 20 kN/m, more preferably of 15 to 18 kN/m.

The integral polyurethane foam preferably has a resilience to DIN 53512 (2000) of 15% to 25%, more preferably of 20% to 25%.

The invention further relates to the use of the prepolymer of the invention or of the integral polyurethane foam of the invention for production of shoe soles, especially for production of shoe soles for sports shoes or hiking shoes.

In a first embodiment, the invention relates to a process for preparing a prepolymer for production of an integral polyurethane foam, wherein the prepolymer is obtained or obtainable by conversion of a composition comprising or consisting of the following components:

component A comprising or consisting of
a polyoxymethylene-polyoxyalkylene block copolymer having a hydroxyl number to DIN 53240-2 (November 2007) DIN 53240-1:2013-06 of 20 mg KOH/g to 200 mg KOH/g as component A1,
optionally a polymer that is different than component A1 and has an average number of at least 1.7 Zerewitinoff-active hydrogen atoms and a hydroxyl number to DIN 53240-2 (November 2007) of 40 mg KOH/g to 80 mg KOH/g as component A2,
optionally a compound that is different from components A1 and A2 and has at least two Zerewitinoff-active hydrogen atoms and a molecular weight of 50 to 500 g/mol as component A3,
   component B comprising or consisting of di- and/or polyisocyanates having an NCO content to EN ISO 11909 (2007) of 15% to 45% by weight, based on component B,
   0.04% to 1.0% by weight, based on the composition, of a protic acid as component C,
   and optionally a component D comprising auxiliaries,
   at an index of 450 to 850.

In a second embodiment, the invention relates to a process according to embodiment 1, wherein component A1 consists of a polyoxymethylene-polypropylene oxide block copolymer or a polyoxymethylene-polyoxyalkylene carbonate block copolymer, where the block copolymer preferably has two terminal polyoxyalkylene blocks.

In a third embodiment, the invention relates to a process according to either of embodiments 1 and 2, wherein at least component A1 has been prepared in the presence of a double metal cyanide catalyst, and component A1 still contains at least some of this double metal cyanide catalyst, where the content of double metal cyanide catalyst based on component A is 10 to 5000 ppm, preferably 1000 to 2500 ppm, and the content of double metal cyanide catalyst is ascertained by the amount of metal from the double metal cyanide catalyst found according to DIN ISO 17025 (August 2005).

In a fourth embodiment, the invention relates to a process according to embodiment 3, wherein the amount of component C used is chosen such that the molar amount of the metals of the double metal cyanide catalyst n_{Met}(DMC) ascertained to DIN-ISO 17025 (August 2005) to the molar amount of component C n(C) is subject to the following relationship:

$${n}_{Met} ( DMC ) \cdot f = n ( C )$$

where f is a number from 1.0 to 20.0, preferably from 1.2 to 10.0, further preferably from 3.0 to 6.0, especially preferably from 3.5 to 5.0.

In a fifth embodiment, the invention relates to a process according to any of the preceding embodiments, wherein component A1 has a hydroxyl number to DIN 53240-2 (November 2007) of 30 mg KOH/g to 150 mg KOH/g, preferably of 40 mg KOH/g to 100 mg KOH/g.

In a sixth embodiment, the invention relates to a process according to any of the preceding embodiments, wherein component A2 comprises or consists of a polyether polyol, polyester polyol, polyether ester polyol, polycarbonate polyol or polyacrylate polyol or mixtures thereof, where component A2 preferably comprises or consists of a branched polypropylene oxide.

In a seventh embodiment, the invention relates to a process according to any of the preceding embodiments, wherein component A3 comprises or consists of diethanolamine, ethylenediamine, glycerol, tripropylene glycol, trimethylolpropane or mixtures thereof, where component A3 preferably comprises or consists of tripropylene glycol.

In an eighth embodiment, the invention relates to a process according to any of the preceding embodiments, wherein component B comprises carbodiimide-modified diisocyanates having an NCO content to EN ISO 11909 (2007) of 20% to 50% by weight, based on the carbodiimide-modified diisocyanates.

In a ninth embodiment, the invention relates to a process according to any of the preceding embodiments, wherein component C is an inorganic acid, a carboxylic acid, a halogenated carboxylic acid, a dicarboxylic acid, a hydroxycarboxylic acid, a sulfonic acid, a phosphoric acid or a phosphoric acid derivative, where component C is preferably dibutyl phosphate, hydrochloric acid or 2-chloropropionic acid.

In a tenth embodiment, the invention relates to a process according to any of the preceding embodiments, wherein 0.04% to 0.5% by weight, preferably 0.04% to 0.3% by weight, of component C is present in the composition, based in each case on the composition.

In an eleventh embodiment, the invention relates to a process according to any of the preceding embodiments, wherein the prepolymer is obtained or obtainable by conversion of a composition comprising or consisting of
10.50% by weight to 30.50% by weight of component A1,
0.50% by weight to 3.50% by weight of component A2,
1.00% by weight to 8.00% by weight of component A3,
67.85% by weight to 77.65% by weight of component B,
0.05% to 0.2% by weight of component C,
0.10% to 0.20% by weight of component D,
   where the percentages by weight are based on the sum total of all components of the composition, at an index of 600 to 650, preferably at an index of 610 to 630.

In a twelfth embodiment, the invention relates to a prepolymer obtained or obtainable by a process according to any of embodiments 1 to 11.

In a thirteenth embodiment, the invention relates to a prepolymer according to embodiment 12, wherein the prepolymer has an NCO content to EN ISO 11909 (2007) of 15% to 30% by weight, preferably of 18% to 21% by weight, based on the mass of the prepolymer.

In a fourteenth embodiment, the invention relates to a prepolymer according to embodiment 12 or 13, wherein the prepolymer, after storage at 80° C. for three days, has an NCO content to EN ISO 11909 (2007) that is not more than 10% lower, preferably not more than 3% lower, than the NCO content of the prepolymer on commencement of storage.

In a fifteenth embodiment, the invention relates to a prepolymer according to any of embodiments 12 to 14, wherein the prepolymer has a dynamic viscosity at 50° C. to DIN 53019 (2008) of ≤0.30 Pa*s, preferably ≤0.15 Pa*s, measured with a rheometer having a cone-plate configuration with a separation of 1 mm, at 25° C. and with a shear of 0.01 to 1000 l/s, the dynamic viscosity being the average of all measurement points that have been measured at an interval of 10 seconds for a period of 10 minutes.

In a sixteenth embodiment, the invention relates to a prepolymer according to any of embodiments 12 to 15, wherein the prepolymer, after storage at 80° C. for three days, has a dynamic viscosity at 50° C. to DIN 53019 (2008) that is not more than 50% higher, preferably not more than 40% higher, than the dynamic viscosity of the prepolymer on commencement of storage, where the dynamic viscosity is measured in each case with a rheometer having a cone-plate configuration with a separation of 1 mm, at 25° C. and with a shear of 0.01 to 1000l/s, the dynamic viscosity being the average of all measurement points that have been measured at an interval of 10 seconds for a period of 10 minutes.

In a seventeenth embodiment, the invention relates to an integral polyurethane foam obtained or obtainable by conversion of a composition comprising or consisting of
a prepolymer according to one of embodiments 12 to 16,
a polyol component having a hydroxyl number to DIN 53240-2 (November 2007) of 140 mg KOH/g to 200 mg KOH/g,
optionally auxiliaries and additives,
   at an index of 85 to 110.

In an eighteenth embodiment, the invention relates to an integral polyurethane foam according to embodiment 17, wherein the integral polyurethane foam has a molded density of 450 to 700 g/l, preferably of 550 to 650 g/l, the molding density being calculated by means of the volume and mass of a test specimen made of the integral polyurethane foam.

In a nineteenth embodiment, the invention relates to an integral polyurethane foam according to embodiment 17 or 18, characterized in that the integral polyurethane foam has a Shore A hardness to DIN ISO 7619-1 (2012) of 50 to 65, preferably of 55 to 62.

In a twentieth embodiment, the invention relates to an integral polyurethane foam according to any of embodiments 17 to 19, wherein the integral polyurethane foam has a tensile strength to DIN EN ISO 1798 (2008) of 2.5 to 9 MPa, preferably of 3 to 5 MPa.

In a twenty-first embodiment, the invention relates to an integral polyurethane foam according to any of embodiments 17 to 20, wherein the integral polyurethane foam has a tensile elongation to DIN EN ISO 1798 (2008) of 200% to 400%, preferably of 250% to 380%.

In a twenty-second embodiment, the invention relates to an integral polyurethane foam according to any of embodiments 17 to 21, wherein the integral polyurethane foam has a tear resistance to DIN EN ISO 8067 (2009) of 15 to 20 kN/m, preferably of 15 to 18 kN/m.

In a twenty-third embodiment, the invention relates to an integral polyurethane foam according to any of embodiments 17 to 22, wherein the integral polyurethane foam has a resilience to DIN 53512 (2000) of 15% to 25%, preferably of 20% to 25%.

In a twenty-fourth embodiment, the invention relates to the use of a prepolymer according to any of embodiments 12 to 16 or of an integral polyurethane foam according to any of embodiments 17 to 23 for production of shoe soles, especially for production of shoe soles for sports shoes or hiking shoes.

### EXAMPLES

The present invention is elucidated further by the examples that follow, but without being restricted thereto.

### Synthesis of Prepolymers

Various prepolymers were prepared, and their dynamic viscosity and their NCO content were examined before and after storage at 80° C. under nitrogen atmosphere for 3 days.

### Methods

Amount of catalyst: The contents of Co and Zn in the polyoxymethylene-polypropylene oxide block copolymer (polyol 2) were determined to DIN-ISO 17025 (August 2005). Given the molecular weight of the DMC catalyst, these were used to calculate the amount of catalyst in polyol 2. Since only polyol 2 contained DMC catalyst residues, the molar mass ascertained thus corresponds to the total amount of DMC catalyst in component A.

OH number: The OH number (hydroxyl number) was determined in accordance with DIN 53240-2 (November 2007).

NCO content: The NCO content was determined in accordance with EN ISO 11909 (2007).

Dynamic viscosity: Dynamic viscosity was ascertained to DIN 53019 (2008), using a Physica MCR 501 rheometer from Anton Paar. A cone-plate configuration having a separation of 1 mm was selected (DCP25 measurement system). The prepolymer (0.1 g) was applied to the rheometer plate and subjected to a shear of 0.01 to 1000 l/s at 25° C., and the viscosity was measured every 10 s for 10 min. The figure reported is the viscosity averaged over all measurement points.

### Penetration Depth

Penetration depth was determined using a test machine in which a test ram was forced into a beaker containing the polyurethane foam to be tested with the aid of a defined weight for a defined period of time in the foam. In the present invention, the test ram had the shape of a rod having a diameter of 8 mm. The reaction mixture was mixed with a Pendraulik overhead mixer at 1400 rpm for 10 s and introduced into a paper cup of volume 245 ml. 75 sec after commencement of mixing, the machine's test ram was forced into the fresh free-risen foam with a weight of 505 g for 90 sec, and then the penetration depth was registered. The lower the penetration depth, the greater the extent of reaction through the foam. In order to determine the optimum, the experiment is conducted at different indices, assuming the lowest penetration depth to be the optimum.

Molding density and free-risen foam density: Molding density and free-risen foam density were calculated from the volume and mass of the test specimen.

Shore A hardness: Shore A hardness was determined in accordance with DIN ISO 7619-1 (2012).

Tensile strength and tensile elongation: Tensile strength and tensile elongation were determined in accordance with DIN EN ISO 1798 (2008).

Tear resistance: Tear resistance was determined to DIN EN ISO 8067 (2009).

Resilience: Rebound was determined in accordance with DIN 53512 (2000).

Materials
Isocyanate 1: methylene diphenyl 4,4′-diisocyanate, NCO content 33.6% by weight; Desmodur® 44M (Covestro AG Deutschland)
Isocyanate 2: carbodiimide-modified methylene diphenyl 4,4′-diisocyanate, NCO content 29.5% by weight; Desmodur® CD-S (Covestro AG Deutschland)
Isocyanate 3: 5% by weight of HCl in a mixture of methylene diphenyl 2,4′-diisocyanate and methylene diphenyl 4,4′-diisocyanate (11:9 parts by weight) obtained by sparging of MDI with hydrogen chloride
Polyol 1: 1,2-propylene glycol-started polypropylene oxide with an OH number of 56 mg KOH/g, prepared under KOH catalysis (contains 0.54% by weight of H₂SO₄)
Polyol 2: polyoxymethylene-polypropylene oxide block copolymer having an OH number of 57 mg KOH/g, prepared under double metal cyanide catalysis, the double metal cyanide catalyst having been prepared according to example 6 of WO 01/80994 A1
Polyol 3: glycerol-started polypropylene oxide with an OH number of 56 mg KOH/g, prepared under KOH catalysis
Polyol 4: tripropylene glycol from Sigma Aldrich
2-chloropropionic acid (CPA) from Sigma Aldrich
Dibutyl phosphate (DBP)
Antioxidant: Irganox 1135, commercial product from BASF, benzenepropionic acid 3,5-bis(1,1-dimethylethyl)-4-hydroxy C7-C9 alkyl ester

### Reference Example 1

### Preparation of an Unstabilized Prepolymer Based on Polypropylene Oxide

An initial charge of 361 g of isocyanate 1 in a 1 l four-neck flask with gas inlet, reflux condenser, stirrer and dropping funnel under nitrogen was heated up to 80° C. while stirring. Added to this solution was a polyol mixture consisting of 92.8 g of polyol 1, 12.5 g of polyol 3, 33.6 g of polyol 4 and 0.48 g of Irganox 1135 at such a rate that the temperature does not exceed 80° C. On completion of addition, the mixture was stirred at 80° C. for 2 hours.

### Reference Example 2

### Preparation of an Unstabilized Prepolymer Based on POM-PO Block Copolymers

An initial charge of 3560 g of isocyanate 1 and 50 g of isocyanate 2 in a 6 l four-neck flask with gas inlet, reflux condenser, stirrer and dropping funnel under nitrogen was heated up to 80° C. while stirring. Added to this solution was a polyol mixture consisting of 925 g of polyol 2, 125 g of polyol 3, 335 g of polyol 4 and 4.8 g of Irganox 1135 at such a rate that the temperature does not exceed 80° C. On completion of addition, the mixture was stirred at 80° C. for 2 hours.

### Reference Example 3

### Preparation of a CPA-Stabilized Prepolymer Based on POM-PO Block Copolymers

An initial charge of 4327 g of isocyanate 1 in a 6 l four-neck flask with gas inlet, reflux condenser, stirrer and dropping funnel under nitrogen was heated up to 80° C. while stirring. Added to this solution was a polyol mixture consisting of 1113 g of polyol 2, 150 g of polyol 3, 403 g of polyol 4 and 5.7 g of Irganox 1135, and also 0.6 g of CPA, at such a rate that the temperature does not exceed 80° C. On completion of addition, the mixture was stirred at 80° C. for 2 hours.

### Example 4 (According to the Invention)

### Preparation of an HCl-Stabilized Prepolymer Based on POM-PO Block Copolymers

An initial charge of 2113 g of isocyanate 1, 30 g of isocyanate 2 and 23.4 g of isocyanate 3 in a 4 l four-neck flask with gas inlet, reflux condenser, stirrer and dropping funnel under nitrogen was heated up to 80° C. while stirring. Added to this solution was a polyol mixture consisting of 555 g of polyol 2, 75 g of polyol 3, 210 g of polyol 4 and 3.0 g of Irganox 1135 at such a rate that the temperature does not exceed 80° C. On completion of addition, the mixture was stirred at 80° C. for 2 hours.

### Example 5 (According to the Invention)

### Preparation of a CPA-Stabilized Prepolymer Based on POM-PO Block Copolymers

An initial charge of 356 g of isocyanate 1 and 5.0 g of isocyanate 2 in a 500 ml four-neck flask with gas inlet, reflux condenser, stirrer and dropping funnel under nitrogen was heated up to 80° C. while stirring. Added to this solution was a polyol mixture consisting of 92.3 g of polyol 2, 12.5 g of polyol 3, 33.4 g of polyol 4, 0.5 g of Irganox 1135 and 0.5 g of CPA at such a rate that the temperature does not exceed 80° C. On completion of addition, the mixture was stirred at 80° C. for 2 hours.

### Example 6 (According to the Invention)

### Preparation of a DBP-Stabilized Prepolymer Based on POM-PO Block Copolymers

An initial charge of 1795 g of isocyanate 1 and 2.4 g of isocyanate 2 in a 4 l three-neck flask with gas inlet, reflux condenser, stirrer and dropping funnel under nitrogen was heated up to 80° C. while stirring. Added to this solution was a polyol mixture consisting of 466 g of polyol 2, 63.1 g of polyol 3, 169 g of polyol 4, 2.4 g of Irganox 1135 and 1.5 g of DBP at such a rate that the temperature does not exceed 80° C. On completion of addition, the mixture was stirred at 80° C. for 2 hours.

### Storage Stability of the Prepolymers

The prepolymers obtained in examples 1-5 were stored at 80° C. under nitrogen atmosphere for 3 days. The dynamic viscosity and NCO value of the prepolymers before and after aging are shown in table 1. The prepolymer should have an NCO content of 15% to 25% by weight and a dynamic viscosity at 50° C. of 100 to 500 mPa*s.

The amounts given in table 1 below are in % by weight based on the sum total of the mass of all components.
n_{Met} (DMC)=molar amount of the metals in the double metal cyanide catalyst ascertained to DIN-ISO 17025 (August 2005)
n(C)=molar amount of component C

TABLE 1
Composition and properties of the prepolymers

| | Reference | | | According to the invention | | |
|---|---|---|---|---|---|---|
| Example/Prepolymer | 1 | 2 | 3 | 4 | 5 | 6 |
| Polyol 1 | 18.5 | — | — | — | — | — |
| Polyol 2 | — | 18.5 | 18.5 | 18.5 | 18.5 | 18.7 |
| Polyol 3 | 2.5 | 2.5 | 2.5 | 2.5 | 2.5 | 2.5 |
| Polyol 4 | 6.7 | 6.7 | 6.7 | 6.7 | 6.7 | 6.8 |
| Irganox 1135 | 0.1 | 0.1 | 0.1 | 0.1 | 0.1 | 0.1 |
| Dibutyl phosphate | — | — | — | — | — | 0.06 |
| 2-Chloropropionic acid | — | — | 0.01 | — | 0.1 | — |
| Isocyanate 1 | 72.1 | 71.2 | 72.1 | 70.4 | 71.2 | 71.8 |
| Isocyanate 2 | | 1 | | 1 | 1 | 0.1 |
| Isocyanate 3 | | — | — | 0.8 | — | — |
| n(C)/n_{Met}(DMC) | — | — | 0.5 | 9.6 | 4.5 | 2.5 |
| DMC content in polyol 2 | | 2000 | 2000 | 1090 | 2000 | 1090 |
| [ppm] | | | | | | |
| NCO index | 634 | 628 | 628 | 628 | 628 | 619 |
| NCO content: [% by wt.] | 20.4 | 16.0 | 19.7 | 20.1 | 20.1 | 20.2 |
| Dyn. viscosity at 25° C. | 550 | (not | 900 | 690 | 830 | 630 |
| [mPa* s] | | measurable) | | | | |
| Dyn. viscosity at 50° C. | — | 10 300 | — | | | |
| [mPa* s] | | | | | | |
| After storage at 80° C. | | | | | | |
| for 3 days | | | | | | |
| NCO content: [% by wt.] | 20.1 | 15.2 | 16.3 | 19.6 | 18.3 | 19.8 |
| Dyn. viscosity at 25° C. | 710 | — | 80 700 | 1 040 | 960 | 840 |
| [mPa* s] | | | | | | |
| Dyn. viscosity at 50° C. | — | 27 700 | — | — | — | — |
| [mPa*s] | | | | | | |
| Differential in NCO | 1.5 | 5.0 | 17.3 | 2.5 | 9.0 | 2.0 |
| content before and after | | | | | | |
| storage [%] | | | | | | |
| Differential in dyn. | 29 | — | 8867 | 51 | 16 | 33 |
| viscosity at 25° C. before | | | | | | |
| and after storage [%] | | | | | | |
| Differential in dyn. | — | 169 | — | — | — | — |
| viscosity at 50° C. before | | | | | | |
| and after storage [%] | | | | | | |

The storage conditions in the examples presented above simulated storage for 6 months at a temperature of 25° C. under protective gas atmosphere.

Reference prepolymer 2 contains a polyoxymethylene-polyoxyalkylene block copolymer, but no acid. This example shows that prepolymers based on a polyoxymethylene-polyoxyalkylene block copolymer without acid have too high a dynamic viscosity to be usable in a production process for a polyurethane, especially when rapid filling of a mold before the components have reacted completely has to be assured. In addition, prepolymer 2 has too low an NCO content, especially after storage.

Prepolymers 4, 5 and 6 according to the invention are prepolymers containing a polyoxymethylene-polyoxyalkylene block copolymer and an acid within the range of the invention. These prepolymers have a sufficiently low dynamic viscosity to be used for the production of an integral polyurethane foam. This is especially true of dynamic viscosity after storage. The NCO content, especially after storage, is also sufficiently high, such that the prepolymer has via sufficient reactivity for the reaction with a polyol component to give a polyurethane. Prepolymers 4, 5 and 6 according to the invention have comparable reactivity to the reference prepolymer 1. The reference prepolymer 1 does not contain any polyoxymethylene-polyoxyalkylene block copolymer, and corresponds to a polyether-based prepolymer typically used for the production of integral polyurethane foams.

### Synthesis of Integral Polyurethane Foams

Prepolymers 1 to 5 were processed together with a polyol component to give integral polyurethane foams.

The following reactants were used for synthesis of the integral polyurethane foams:
prepolymers from examples 4 and 6 as described above
Bayflex S 99-312, commercial product from Covestro Deutschland AG, polyol mixture with a hydroxyl number to DIN 53240-1:2013-06 of 171 mg KOH/g; Bayflex S 99-312 does not contain any polyoxymethylene-polypropylene oxide block copolymer
Desmodur 0960, commercial product from Covestro Deutschland AG, isocyanate mixture having an NCO content to EN ISO 11909 (2007) of 20.4%; Desmodur 0960 does not contain any prepolymer comprising a polyoxymethylene-polypropylene oxide block copolymer

### Table 2: Composition of the Integral Polyurethane Foams

The properties of the prepolymers in the synthesis and the mechanical properties of the resultant integral polyurethane foam were examined. The results are compiled in table 2.

TABLE 3
Properties of the integral polyurethane foams

| | | According | According |
|---|---|---|---|
| | | to the | to the |
| | Reference | invention | invention |
| Example | 7 | 8 | 9 |
| Polyol component | Bayflex | Bayflex | Bayflex |
| | S 99-312 | S 99-312 | S 99-312 |
| Isocyanate component | Desmodur | Prepolymer | Prepolymer |
| | 0960 no | from ex. 6 | from ex. 4 |
| | POM-PO | | |
| Acid present in the | 0.01% by | 0.06% by | Hydrochloric |
| prepolymer | weight of | weight of | acid |
| | CPA | dibutyl | |
| | | phosphate | |
| Index | 100 | 96 | 95 |
| Penetration depth [mm] | 11.4 | 18.5 | 17.3 |
| Cream time [s] | 19 | 15 | 16 |
| Tack-free time [s] | 50 | 52 | 57 |
| Free-risen foam | 288 | 276 | 281 |
| density [g/l] | | | |
| Molded density [g/l] | 612 | 609 | 603 |
| Shore A surface hardness | 54 | 61 | 56 |
| Tensile strength [MPa] | 3.9 | 3.1 | 3.7 |
| Tensile elongation [%] | 304 | 290 | 361 |
| Tear resistance [kN/m] | 14.9 | 17.8 | 15.8 |
| Resilience (Rebound) [%] | 19.1 | 22.8 | 20.1 |

1. A process for preparing a prepolymer for production of an integral polyurethane foam, wherein the prepolymer is obtained or obtainable by conversion of a composition comprising the following components:
component A comprising
a polyoxymethylene-polyoxyalkylene block copolymer having a hydroxyl number according to DIN 53240-2 (November 2007) of 20 mg KOH/g to 200 mg KOH/g as component A1,
component B comprising di- and/or polyisocyanates having an NCO content according to EN ISO 11909 (2007) of 15% to 45% by weight, based on component B,
0.04% to 1.0% by weight, based on the composition, of a protic acid as component C,
at an index of 450 to 850.

2. The process as claimed in claim 1, wherein component A1 consists of a polyoxymethylene-polypropylene oxide block copolymer or a polyoxymethylene-polyoxyalkylene carbonate block copolymer.

3. The process as claimed in claim 1, wherein at least component A1 has been prepared in the presence of a double metal cyanide catalyst, and component A1 still contains at least some of this double metal cyanide catalyst, wherein the content of double metal cyanide catalyst based on component A is 10 to 5000 ppm, the content of double metal cyanide catalyst is ascertained by the amount of metal from the double metal cyanide catalyst found according to DIN-ISO 17025 (August 2005).

4. The process as claimed in claim 3, wherein the amount of component C used is chosen such that the molar amount of the metals of the double metal cyanide catalyst n_{Met}(DMC) ascertained to DIN-ISO 17025 (August 2005) to the molar amount of component C n(C) is subject to the following relationship:
$${n}_{Met} ( DMC ) \cdot f = n ( C )$$
where f is a number from 1.0 to 20.0.

5. The process as claimed in claim 1, wherein component A1 has a hydroxyl number according to DIN 53240-2 (November 2007) of 30 mg KOH/g to 150 mg KOH/g.

6. The process as claimed in claim 1, wherein component A2 comprises or consists of a polyether polyol, polyester polyol, polyether ester polyol, polycarbonate polyol or polyacrylate polyol or mixtures thereof.

7. The process as claimed in claim 1, wherein component A3 comprises diethanolamine, ethylenediamine, glycerol, tripropylene glycol, trimethylolpropane or mixtures thereof.

8. The process as claimed in claim 1, wherein component B comprises carbodiimide-modified diisocyanates having an NCO content according to EN ISO 11909 (2007) of 20% to 50% by weight, based on the carbodiimide-modified diisocyanates.

9. The process as claimed in claim 1, wherein component C is an inorganic acid, a carboxylic acid, a halogenated carboxylic acid, a dicarboxylic acid, a hydroxycarboxylic acid, a sulfonic acid, a phosphoric acid or a phosphoric acid derivative.

10. The process as claimed in claim 1, wherein 0.04% to 0.5% by weight of component C is present in the composition, based in each case on the composition.

11. The process as claimed in claim 1, wherein the prepolymer is obtained by conversion of a composition comprising
10.50% by weight to 30.50% by weight of component A1,
0.50% by weight to 3.50% by weight of component A2,
1.00% by weight to 8.00% by weight of component A3,
67.85% by weight to 77.65% by weight of component B,
0.05% to 0.2% by weight of component C,
0.10% to 0.20% by weight of component D,
where the percentages by weight are based on the sum total of all components of the composition, at an index of 600 to 650.

12. A prepolymer obtained or obtainable by a process as claimed in claim 1.

13. An integral polyurethane foam obtained or obtainable by conversion of a composition comprising
a prepolymer according to claim 12,
a polyol component having a hydroxyl number according to DIN 53240-2 (November 2007) of 140 mg KOH/g to 200 mg KOH/g,
at an index of 85 to 110.

14. A method comprising producing shoe soles with the prepolymer as claimed in claim 12.

15. The process as claimed in claim 1, wherein component A comprises component A2, wherein component A2 is a polymer that is different than component A1, and wherein component A2 has an average number of at least 1.7 Zerewitinoff-active hydrogen atoms and a hydroxyl number of 40 mg KOH/g to 80 mg KOH/g.

16. The process as claimed in claim 15, wherein component A comprises component A3, wherein component A3 is a compound that is different from components A1 and A2, and wherein component A3 has at least two Zerewitinoff-active hydrogen atoms and a molecular weight of 50 to 500 g/mol.

17. The process as claimed in claim 1, wherein the composition comprises a component D comprising auxiliaries.

18. The process as claimed in claim 2, wherein the block copolymer has two terminal polyoxyalkylene blocks.

19. The process as claimed in claim 6, wherein component A2 comprises a branched polypropylene oxide.

20. The process as claimed in claim 9, wherein component C is dibutyl phosphate, hydrochloric acid or 2-chloropropionic acid.
